(19) United States
(12) Patent Application Publication
(10) Pub. No.: US 2016/0186887 A1
(43) Pub. Date: Jun. 30, 2016

(54) VALVE OPERATOR ASSEMBLY WITH INVERTED ROLLER SCREW

(71) Applicant: AKTIEBOLAGET SKF, Göteborg (SE)

(72) Inventors: Jérôme DUBUS, La Riche (FR); Sébastien LECLUSE, Gruffy (FR); Christian BOCH, Chambery (FR)

(21) Appl. No.: 14/904,123

(22) PCT Filed: Jul. 16, 2013
(86) PCT No.: PCT/EP2013/064981

§ 371 Date: Jan. 11, 2016

(51) Int. Cl. F16K 31/50; F16H 25/22

(52) U.S. Cl. CPC F16K 31/508; F16H 25/2252

(57) ABSTRACT

A valve operator assembly is provided for a valve. The assembly includes a housing adapted to be mounted on a bonnet of the valve, an input member rotatably mounted with respect to the housing and an inverted roller screw mechanism and comprising a screw adapted to be connected to a valve stem of the valve, a nut surrounding and coaxial with the screw, the nut being connected to the input member, and a plurality of rollers radially disposed between the screw and the nut.

### CROSS REFERENCE TO RELATED APPLICATION

This is a United States National Stage Application claiming the benefit of International Application Number PCT/EP2013/064981 filed on 16 Jul. 2013, which is incorporated herein by reference in its entirety.

### FIELD OF THE INVENTION

The present invention relates to the fields of valves and manually operable valves, for instance gate valves, control or regulation valves or chokes valves. More particularly, the invention relates to a valve operator assembly for a valve.

### BACKGROUND TO THE INVENTION

Valves are used in a variety of industries to control the flow of fluids. In particular, gate valves are used extensively in the oil and gas industry to control the flow of produced fluids at various stages of production. Most gate valves used in this industry comprise a valve body having a longitudinal flow bore and a transverse gate cavity that intersects the flow bore. A gate having a gate opening extending transversely therethrough is disposed in the gate cavity. A valve stem is provided for moving the gate between an open position, in which the gate opening is aligned with the flow bore, and a closed position, in which the gate opening is offset from the flow bore. The gate cavity of the valve body is covered by a bonnet having an axial bore through which passes the valve stem.

Such a gate valve is associated to a valve operator assembly for selectively driving the valve stem up and down in order to close and open the gate valve. A gate valve may be manually actuated. In this case, the valve operator assembly generally comprises a transmission mechanism to convert the rotational motion of a hand-wheel into axial motion of the valve stem. Since the transmission mechanism is susceptible to back-drive under fluid pressure with the upward force exerted by the fluid, the gate valve can be inadvertently opened or closed. Such back-driving can not only cause problems with the desired flow regulation, but can also lead to injury to an operator, for example from being struck by the rotating hand-wheel. Accordingly, a balance system is generally provided on the valve body of the gate valve to prevent these drawbacks. The system may comprise a balance stem disposed on the valve body and which is exposed to fluid pressure to offset or balance the force exerted on the gate.

The transmission mechanism of the valve operator assembly may be a ball screw mechanism or a planetary roller screw mechanism in order to reduce the required hand-wheel torque to quickly open and close the gate valve with a minimum number of turns. For more details, it is possible for example to refer to the patent EP-B1-1 419 334 (SKF).

With the current design of valve operator assemblies, the required torque on the hand-wheel to open or close the gate valve may be not enough reduced. Otherwise, the required space for a conventional valve operator assembly is large.

### SUMMARY OF THE INVENTION

One aim of the present invention is to overcome these drawbacks.

It is a particular object of the present invention to provide a valve operator assembly for valve, for instance gate valve, control or regulation valve or choke valve, wherein the required torque for manipulating said valve is limited and having a good compactness.

In one embodiment, the valve operator assembly is provided for a valve comprising a valve body, a bonnet connected to the valve body and a valve translating member axially moveable. The assembly comprises a housing adapted to be mounted on the bonnet of the valve, an input member rotatably mounted with respect to the housing and an inverted roller screw mechanism adapted to be connected to the valve translating member and to the input member. The mechanism comprises a screw, a nut surrounding and coaxial with the screw, and a plurality of rollers radially disposed between the screw and the nut and each provided with an outer thread engaging outer and inner threads provided on the screw and the nut and with two outer gear teeth. The mechanism also comprises two gear wheels disposed on the screw and each provided with gear teeth meshing with the gear teeth of the rollers.

Thanks to the use of an inverted roller screw mechanism to convert rotation of the input member into axial translation of the screw, a limited applied torque is required on the input member in order to actuate the screw. The load capacity of the valve operator assembly is increased. The lifetime of the assembly is also increased. Otherwise, the required space for the valve operator assembly is reduced. In one embodiment, the screw may be connected to the valve stem of the valve and the nut may be connected to the input member. Alternatively, the screw may be connected to the input member and the nut may be connected to the valve stem of the valve.

The valve operator assembly may further comprise at least one rolling bearing radially disposed between the nut and the housing. Preferably, the rolling bearing is mounted on an outer surface of the nut. With such a disposition of the at least one rolling bearing, the radial dimension of the valve operator assembly is further decreased.

In one embodiment, the rolling bearing is an angular contact thrust ball bearing. Alternatively, the rolling bearing may be for example a tapered roller bearing or a thrust bearing.

In one embodiment, the input member comprises an adapter sleeve mounted on the nut and an operable wheel connected to the sleeve.

Preferably, the contact diameter D_{contact} between the rollers and the nut is defined by:

$${D}_{contact} \geq \frac{L}{π \times tan ( Φ )}$$

with L corresponding to the lead of the inverted roller screw mechanism, and
with Φ corresponding to a determined non-back-driving factor which is chosen from 0°<Φ≦1°.

The non-back-driving factor may be chosen from 0°<Φ≦0.5°, and is preferably chosen from 0°<Φ≦0.4°.

The contact diameter d_{contact} between the rollers and the screw may be defined by:

$${d}_{contact} \geq \frac{N \times L}{[ ( N + 2 ) \times π \times tan ( Φ ) ]}$$

with N corresponding to the number of starts of the screw thread,
with L corresponding to the lead of the inverted roller screw mechanism, and
with Φ corresponding to the determined non-back-driving factor.

The lead of the mechanism may be from 2 to 20 mm.

In one embodiment, the number of starts of the screw thread may be from 1 to 5. Advantageously, the number is equal to 3. Preferably, the number of starts of the nut thread is equal to the one of the screw thread. In one embodiment, the outer thread of each roller has one start.

The invention also relates to a valve, notably a gate valve, a control or a regulation valve, or a choke valve, comprising a valve body, a bonnet connected to the valve body, a valve translating member axially moveable and a valve operator assembly as previously defined. The valve translating member may be a valve stem or a piston for instance.

### BRIEF DESCRIPTION OF THE DRAWINGS

The present invention and its advantages will be better understood by studying the detailed description of a specific embodiment given by way of a non-limiting example and illustrated by the appended drawings on which:

FIG. 1 is a cross-section of a valve operator assembly for gate valve according to an example of the invention; and

FIG. 2 is a cross-section of an inverted roller screw mechanism of the assembly of FIG. 1.

### DETAILED DESCRIPTION OF THE PRESENT INVENTION

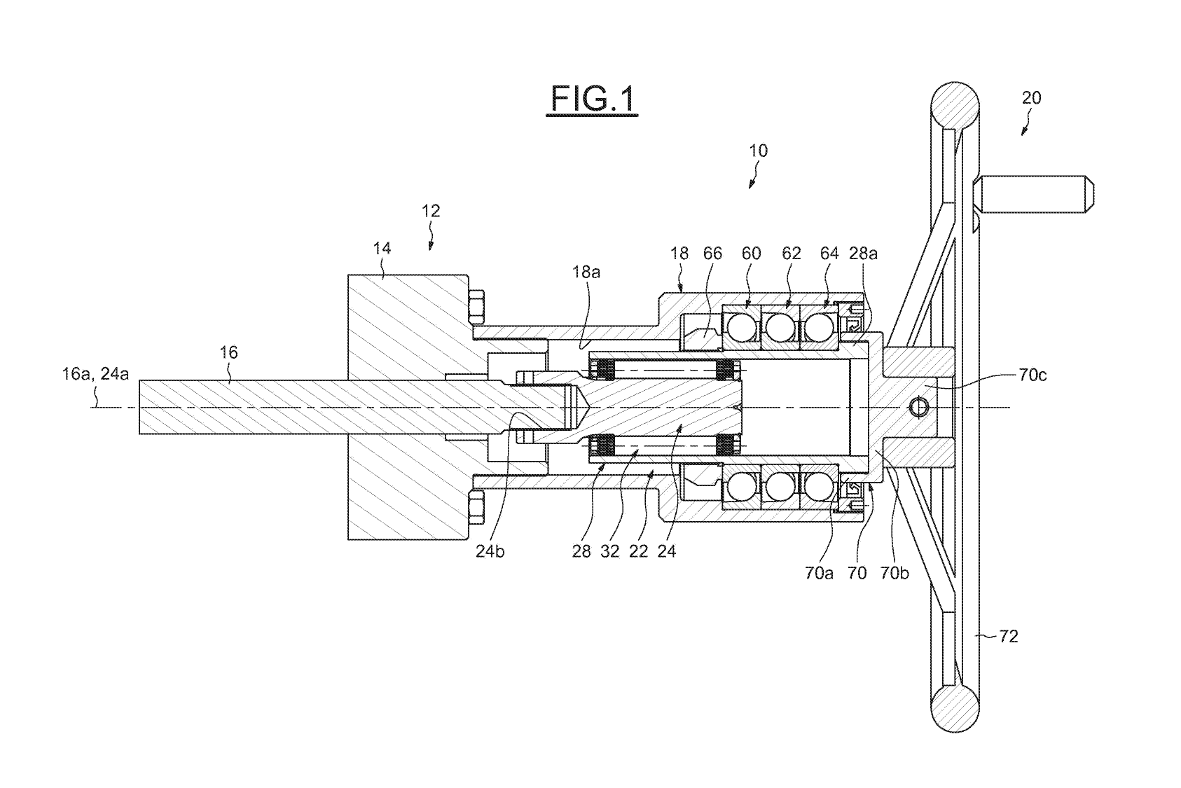

A valve operator assembly 10 as shown on FIG. 1 is adapted for a gate valve 12 provided with a bonnet 14, a valve body (not shown) covered by the bonnet and a moveable valve stem 16 with an axis 16a. Conventionally, the valve body has a longitudinal flow bore and a transverse gate cavity that intersects the flow bore. The gate valve also comprises a gate having a gate opening extending transversely therethrough is disposed in the gate cavity. For more detail on such a gate valve, it could be referred to EP-B1-1 419 334 (SKF) which is hereby incorporated by reference.

The valve operator assembly 10 comprises a tubular housing 18 mounted on the bonnet 14 of the gate valve, an input member 20 rotatably mounted with respect to the housing, and an inverted roller screw mechanism 22 interposed between the input member and the valve stem 16 of the valve to convert a rotational motion of the input member 20 into axial motion of the valve stem. The inverted roller screw mechanism 22 is mounted into a bore 18a of the housing and is connected to the input member 20. One axial end of the housing 18 is secured to the bonnet 14 by threads (not referenced). In the illustrated example, the bore 18a has a stepped form.

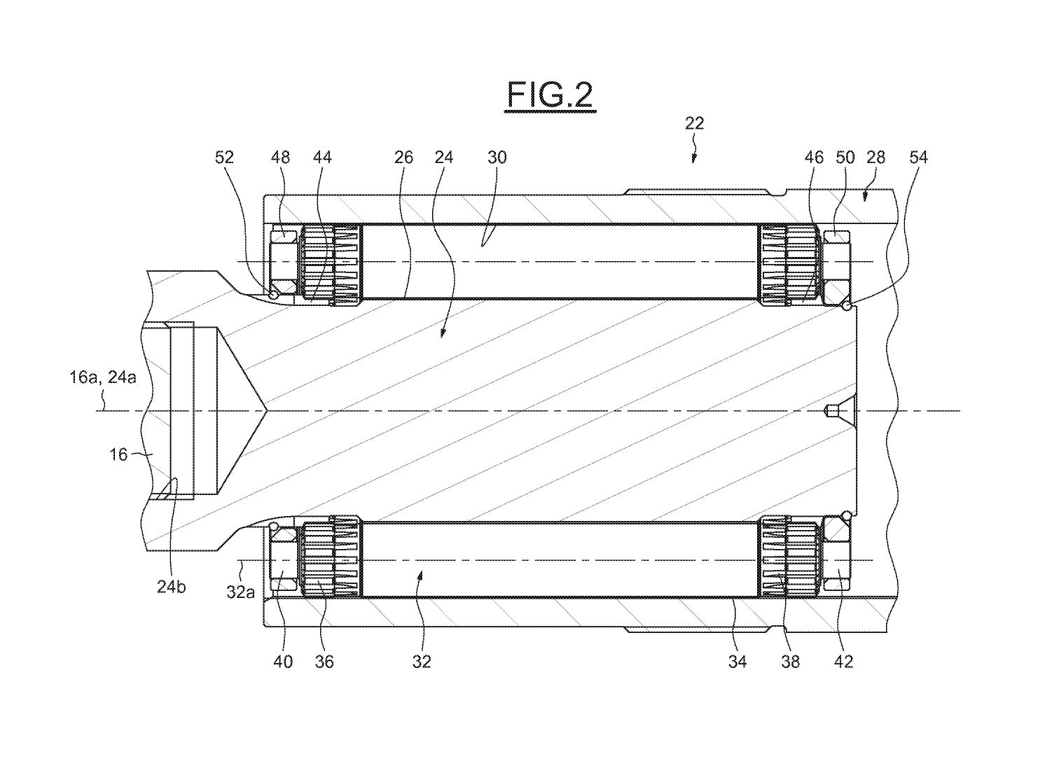

As shown more clearly on FIG. 2, the mechanism 22 comprises a screw 24, with an axis 24a coaxial with the axis 16a of the valve stem 16, provided with an outer thread 26, a nut 28 mounted coaxially about the screw 24 and provided with an inner thread 30, the internal diameter of which is greater than the external diameter of the outer thread 26, and a plurality of longitudinal rollers 32 arranged radially between the screw 24 and the nut 28. The screw 12 extends longitudinally through a cylindrical bore of the nut 28 on which the inner thread 30 is formed. The nut 28 has a tubular form and is elongated to accommodate the full extent of screw travel. Axially on the side opposite to the input member 20 (FIG. 1), a recess 24b is formed on a frontal radial surface of the screw 12 and into which is fixed an end of the valve stem 16 of the gate valve. The valve stem 16 is connected to the screw 24 by any appropriate means, for example by threads and/or a pin.

The rollers 32 are identical to each other and are distributed regularly around the screw 24. Each roller 32 extends along an axis 32a which is coaxial with the axis 24a of the screw and comprises an outer thread 34 engaging the thread 26 of the screw and the thread 30 of the nut. Each roller 20 also comprises, at each axial end, outer gear teeth 36, 38 extending axially outwards the outer thread 34 and which are themselves extended axially by a cylindrical stud 40, 42 extending outwards. Each gear teeth 36, 38 are axially located between the associated stud 40, 42 and the outer thread 34. The outer thread 34 of each roller is axially located between the two gear teeth 36, 38.

The roller screw mechanism 22 also comprises two annular gear wheels 44, 46 provided on the outer surface of the screw 24 and each comprising outer gear teeth meshing the gear teeth 36, 38 respectively of the rollers 32 for the synchronization thereof. Each gear wheel 44, 46 is axially located near to an end of the outer thread 26 of the screw. The outer thread 26 is axially located between the two gear wheels 44, 46. In the disclosed embodiment, the gear wheels 44, 46 are formed directly on the outer surface of the screw 24. Alternatively, the gear wheels may be separate parts which are fixed onto the screw 24.

The mechanism 22 further comprises two annular guides or spacer rings 48, 50 disposed on the outer surface of the screw 24. The spacer rings 48, 50 are radially disposed between the screw 24 and the inner thread 30 of the nut without contact with the thread. Each spacer ring 48, 50 is mounted on the outer surface of the screw 24 axially next to the associated gear wheel 44, 46. Each spacer ring 48, 50 is axially offset towards the outside of the nut 28 with regard to the associated gear wheel 44, 46. Each spacer ring 48, 50 comprises a plurality of cylindrical through-recesses (not referenced) which are distributed regularly in the circumferential direction and inside which the studs 40, 42 of the rollers are housed. The spacer rings 48, 50 enable the rollers 32 to be carried and the regular circumferential spacing thereof to be kept. The mechanism 22 further comprises elastic retainer rings 52, 54 each mounted in a groove (not referenced) formed on the outer surface of the screw 24 in order to axially hold the corresponding spacer ring 48, 50.

Referring once again to FIG. 1, the valve operator assembly 10 further comprises rolling bearings 60 to 64 to guide the rotation of the nut 28 of the inverted roller screw mechanism. The rolling bearings 60 to 64 are radially mounted between the outer surface of the nut 28 and the stepped bore 18a of the housing. The rolling bearings 60 to 64 are mounted radially in contact with the outer surface of the nut 28 and a large diameter portion of the stepped bore 18a of the housing. In the disclosed example, the rolling bearings 60 to 64 are angular contact thrust ball bearings and are disposed axially in contact one to another. A retaining ring 66 is secured on the outer surface of the nut 28 and axially bears against the rolling bearing 60. Axially on the opposite side, the rolling bearing 64 is axially mounted against a flange 28a of the nut 28 extending radially outwards the outer surface of the nut. The flange 28a is axially located at an axial end of the nut.

The input member 20 comprises an adapter sleeve 70 mounted on the nut 28 and a hand-wheel 72 secured to the sleeve. The sleeve 70 comprises an annular axial portion 70a secured to the flange 28a of the nut by any appropriate means, for example by threads, a radial portion 70b extending radially inwards the axial portion 70a and bearing axially against the end of the nut, and a pin 70c projecting axially outwards from towards the radial portion 70b and onto which is secured the hand-wheel 72. Sealing means (not referenced) are provided between the axial portion 70a of the sleeve and the bore of the housing 18.

When an operator applies a torque on the hand-wheel 72, this torque is transmitted to the adapter sleeve 70 and then to the nut 28 of the inverted roller screw mechanism. With the rotation of the nut 28, the rollers 32 rotate on themselves about the screw 24 and move axially and additionally rotate in the nut 28. The rollers 32 are rotationally guided by outer gear wheels 44, 46 provided on the screw and meshing with the gear teeth of the rollers. Both the rollers 32 and the screw 12 are axially or longitudinally moveable into the nut 28. Accordingly, the rotational motion of a hand-wheel 72 is converted into an axial motion of the valve stem 16 of the valve gate.

With the use of the inverted roller screw mechanism 22, a limited applied torque is required on the hand-wheel 72 in order to actuate the valve stem 16. Besides, the required torque is limited since lead of the screw 24 is preferably selected with small values as described later. The load capacity of the valve operator assembly 10 is increased since the inverted roller screw mechanism thread geometry can be larger than with a conventional roller screw since there is no minimum number of starts required. This increases load capacity while keeping compactness advantage. The lifetime of the assembly 10 is also increased. Otherwise, the required space for the assembly 10 is reduced. Besides, thanks to the disposition of the rolling bearings 60 to 64 directly on the outer surface of the nut 28 of the inverted roller screw mechanism, the radial dimension of the valve operator assembly 10 is further decreased.

In order to avoid back-drive of the inverted roller screw mechanism 22 under fluid pressure on the valve gate, the contact diameter D_{contact} between the rollers 32 and the nut 28 in mm is advantageously defined by:

$${D}_{contact} \geq \frac{L}{π \times tan ( Φ )}$$

with L corresponding to the lead of the inverted roller screw mechanism, and
with Φ corresponding to a determined non-back-driving factor which is chosen from 0°<Φ≦1°. The lead is the axial travel per turn. The contact diameter is equal to the diameter on thread flanks of the nut where rollers 32 are in contact.

With such a contact diameter D_{contact} between the rollers 32 and the nut 28, the indirect efficiency of the inverted roller screw mechanism 22 equals zero or is very close to zero. The indirect efficiency defines the axial load required to transform the translation of the screw 24 into a rotation of the nut 28.

As previously indicated the non-back-driving factor Φ is greater than 0° and less than or equal to 1°. With a non-back-driving factor Φ less than or equal to 0.4°, the prevention of the back-driving of the inverted roller screw mechanism 22 is guaranteed. Accordingly, under fluid pressure exerted both on the valve stem 16 and the screw 24, the mechanism 22 is not reversible or back-driveable. The force exerted by the fluid is not transformed into a rotation of the nut 28. The mechanism 22 is not reversible even with an optimal and minimum internal friction created into the mechanism and/or into the assembly.

With a non-back-driving factor Φ greater than 0.4° and less than or equal to 0.5°, the indirect efficiency of the inverted roller screw mechanism 22 is very close to zero and the prevention of the back-driving of the inverted roller screw mechanism 22 is obtained with the internal friction created into the mechanism which generates a braking torque preventing the rotation of the nut 28 under an axial load exerted by the fluid on the screw 24. With a non-back-driving factor Φ greater than 0.5° and less than or equal to 1°, the prevention of the back-driving of the inverted roller screw mechanism 22 may also obtained with the internal friction created into the mechanism and/or into the assembly 10.

Thanks to the contact diameter D_{contact} as previously defined, it is possible to not foresee a balance system, such as a balance stem, on the valve body of the gate valve to avoid back-driving of the mechanism 22.

Preferably, for a valve operator assembly 10 used with a surface valve gate and with a subsea valve gate, the lead of the inverted roller screw mechanism 22 may be respectively from 2 to 6 mm, and from 2 to 20 mm. The number of starts of the screw thread may be advantageously from 1 to 5 and preferably equal to 3. Preferably, the number of starts of the nut thread is equal to the one of the screw thread. Preferably, the outer thread of each roller 36 has only one start.

The contact diameter d_{contact} between the rollers 32 and the screw 24 in mm is advantageously defined by:

$${d}_{contact} \geq \frac{N \times L}{[ ( N + 2 ) \times π \times tan ( Φ ) ]}$$

with N corresponding to the number of starts of the screw thread,
with L corresponding to the lead of the inverted roller screw mechanism in mm, and
with Φ corresponding to the determined non-back-driving factor. The contact diameter is equal to the diameter on thread flanks of the screw where rollers 32 are in contact.

Thanks to the use of the inverted roller screw mechanism, the applied torque required to actuate the valve gate is reduced and the load capacity of the valve operator assembly is also increased. Otherwise, with the use of a screw mechanism having a contact diameter between the rollers and the nut as previously defined, the mechanism is not reversible or back-driveable and there is no need to provide a balance system on the valve body of the gate valve to avoid back-driving. Besides, the required torque for moving the screw towards the input member is reduced with the indirect efficiency of the mechanism which equals or is very close to zero.

Although the invention has been illustrated on the basis of a valve operator comprising a screw connected to the valve stem of the gate and a nut connected to the input member, it should be understood that the invention can be applied with a screw connected to the input member and a nut connected to the valve stem. Although the invention has been illustrated on the basis of a valve operator assembly for gate valve, it should be understood that the invention can also be used with other types of valves, for instance control or regulation valves or choke valves. The valve operator assembly may be used for instance with a surface valve or with a subsea valve which may be actuated by a remote operating vehicle (ROV).

1. Valve operator assembly for valve comprising a valve body, a bonnet connected to the valve body and a valve translating member axially moveable, characterized in that the assembly comprises a housing (18) adapted to be mounted on the bonnet of the valve, an input member (20) rotatably mounted with respect to said housing and an inverted roller screw mechanism (22) adapted to be connected to the valve translating member and to the input member (20), said mechanism comprising:
a screw (24),
a nut (28) surrounding and coaxial with said screw,
a plurality of rollers (32) radially disposed between the screw and the nut and each provided with an outer thread (34) engaging outer and inner threads (26, 30) provided on the screw and the nut and with two outer gear teeth (36, 38), and
two gear wheels (44, 46) disposed on the screw and each provided with gear teeth meshing with said gear teeth of the rollers.

2. Valve operator assembly according to claim 1, further comprising at least one rolling bearing (60) radially disposed between the nut (28) and the housing (18).

3. Valve operator assembly according to claim 2, wherein said rolling bearing is mounted on an outer surface of the nut.

4. Valve operator assembly according to claim 2 or 3, wherein said rolling bearing is an angular contact thrust ball bearing.

5. Valve operator assembly according to any of the preceding claims, wherein the input member (20) comprises an adapter sleeve (70) mounted on the nut (28) or on the screw and an operable wheel (72) connected to said sleeve.

6. Valve operator assembly according to any of the preceding claims, wherein the contact diameter (D_{contact}) between the rollers (32) and the nut (28) is defined by:
$${D}_{contact} \geq \frac{L}{π \times tan ( Φ )}$$
with L corresponding to the lead of the inverted roller screw mechanism, and
with Φ corresponding to a determined non-back-driving factor which is chosen from 0°<Φ≦1°.

7. Valve operator assembly according to claim 6, wherein the non-back-driving factor is chosen from 0°<Φ≦0.5°.

8. Valve operator assembly according to claim 7, wherein the non-back-driving factor is chosen from 0°<Φ≦0.4°.

9. Valve operator assembly according to any of the preceding claims 6 to 8, wherein the contact diameter (d_{contact}) between the rollers (32) and the screw (24) is defined by:
$${d}_{contact} \geq \frac{N \times L}{[ ( N + 2 ) \times π \times tan ( Φ ) ]}$$
with N corresponding to the number of starts of the screw thread,
with L corresponding to the lead of the inverted roller screw mechanism, and
with Φ corresponding to said determined non-back-driving factor.

10. Valve operator assembly according to any of the preceding claims 6 to 9, wherein the lead (L) is from 2 to 20 mm.

11. Valve operator assembly according to any of the preceding claims 6 to 10, wherein the number (N) of starts of the screw thread is from 1 to 5.

12. Valve operator assembly according to claim 11, wherein said number is equal to 3.

13. Valve operator assembly according to any of the preceding claims, wherein the number of starts of the nut thread is equal to the one of the screw thread.

14. Valve operator assembly according to any of the preceding claims, wherein the outer thread of each roller has one start.

15. Valve comprising a valve body, a bonnet (14) connected to the valve body, a valve translating member (16) axially moveable and a valve operator assembly (10) according to any of the preceding claims.
